(19) United States
(12) Patent Application Publication
(10) Pub. No.: US 2015/0112653 A1
(43) Pub. Date: Apr. 23, 2015

(54) Smoothed Particle Galerkin Formulation for Simulating Physical Behaviors in Solids Mechanics

(71) Applicant: Livermore Software Technology Corporation, Livermore, CA (US)

(72) Inventor: Cheng-Tang Wu, Livermore, CA (US)

(73) Assignee: Livermore Software Technology Corporation, Livermore, CA (US)

(21) Appl. No.: 14/181,292

(22) Filed: Feb. 14, 2014

Related U.S. Application Data
(60) Provisional application No. 61/893,191, filed on Oct. 19, 2013.

(51) Int. Cl. G06F 17/50

(52) U.S. Cl. CPC G06F 17/5009
USPC 703/2

(57) ABSTRACT

Methods and systems for conducting numerical simulation of structural behaviors in solid mechanics using smoothed particle Galerkin formulation are disclosed. A meshfree model representing a physical domain defined by a plurality of particles is received in a computer system. Each particle is configured for material properties of portion of the physical domain it represents. A smoothed displacement field of the physical domain subject to defined boundary condition is obtained by conducting a time-marching simulation using the meshfree model based on smoothed particle Galerkin formulation. The smoothed displacement field is derived from a set of smoothed meshfree shape functions that satisfies linear polynomial reproduction condition. The set of smoothed meshfree shape functions is constructed by convex meshfree approximation scheme and configured to avoid calculation second order derivatives. The set of smoothed meshfree shape functions is a combination of regular meshfree shape function and a displacement smoothing function for the particles.

### FIELD

The present invention generally relates to computer aided engineering analysis, more particularly to systems and methods of smoothed particle Galerkin formulation for numerically simulating physical behaviors in solid mechanics.

### BACKGROUND

Meshfree, or particle methods, offer many numerical advantages over conventional finite element and finite difference methods in modeling large deformation and moving discontinuity problems in solid and structural applications. Those methods were also found to be very effective in reducing the volumetric locking and shear locking in the solid and structural analyses. The earliest development in meshfree methods was the Smoothed Particle Hydrodynamics (SPH) method. In this method, partial differential equations are transformed into integral equations and the kernel estimate then provides the approximation to estimate the field variables at discrete particles. Since the functions are evaluated only at particles, the use of a mesh is no longer required. The ability to handle severe deformations without the use of meshes in fluid-like motion allows SPH method to be applied to problems that historically have been reserved for Eulerian approaches. Nevertheless, a direct application of SPH method to solid and structural analyses suffers from several numerical deficiencies, namely the lack of approximation consistency, tension instability, diffusion in material history information, presence of spurious or zero-energy modes and difficulty in enforcing the essential boundary conditions.

The presence of spurious or zero-energy modes in SPH or other Galerkin-based meshfree methods is mainly due to the rank instability caused by the under-integration of the weak forms inherent in the central difference formula from nodal integration approach. Several meshfree nodal integration methods have been developed to eliminate the spurious zero or near-singular modes due to rank instability. However prior art approaches have been generally ad hoc and background mesh dependent.

Therefore, it would be desirable to have improved systems and methods of numerically simulating physical behaviors in solid mechanics using meshfree or particle approaches to avoid aforementioned shortcomings.

### BRIEF SUMMARY

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Methods and systems for conducting numerical simulation of physical behaviors in solid mechanics using smoothed particle Galerkin formulation are disclosed. According to one aspect of the invention, a meshfree model representing a physical domain defined by a plurality of particles is received in a computer system. Each particle occupies a portion of the physical domain and is configured for the physical domain's material properties. Boundary conditions along border of the physical domain for prescribed displacements and pressures are also defined therein. A smoothed displacement field of the physical domain subject to defined boundary condition is obtained by conducting a time-marching simulation using the meshfree model based on smoothed particle Galerkin formulation. The smoothed displacement field is derived from a set of smoothed meshfree shape functions that satisfies linear polynomial reproduction condition. The smoothed meshfree shape function is constructed by convex meshfree approximation scheme and is configured to avoid calculation second order derivatives. The smoothed meshfree shape function is a combination of regular meshfree shape function and a displacement smoothing function for the plurality of particles. In order to efficiently conduct the time-marching simulation, each particle is assigned a domain of influence. Only those particles located within said each particle's domain of influence are considered in the computations while particles located outside are ignored

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1 is a flowchart illustrating an exemplary process of conducting numerical simulation of a smoothed displacement field of a physical domain using a smoothed particle Galerkin formulation in solid mechanics in accordance with an embodiment of the present invention;

FIG. 2 is a diagram showing an exemplary two-dimensional domain represented by particles in accordance with one embodiment of the present invention;

FIG. 3 is a diagram demonstrating structural behaviors of an exemplary two-dimensional domain are calculated in accordance with one embodiment of the present invention;

FIG. 4 is a graphic display showing an exemplary meshfree shape function that can be used in smoothed particle Galerkin formulation according to an embodiment of the present invention;

FIG. 5 is a diagram showing the relationship between different nodal position systems in accordance with one embodiment of the present invention; and

FIG. 6 is a diagram showing the relationship between different domains in accordance with one embodiment of the present invention; and

FIG. 7 is a function diagram showing salient components of an exemplary computer system, in which an embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

Embodiments of the present invention are discussed herein with reference to figures. However, those skilled in the art will readily appreciate that the detailed description given herein with respect to these figures is for explanatory purposes as the invention extends beyond these limited embodiments.

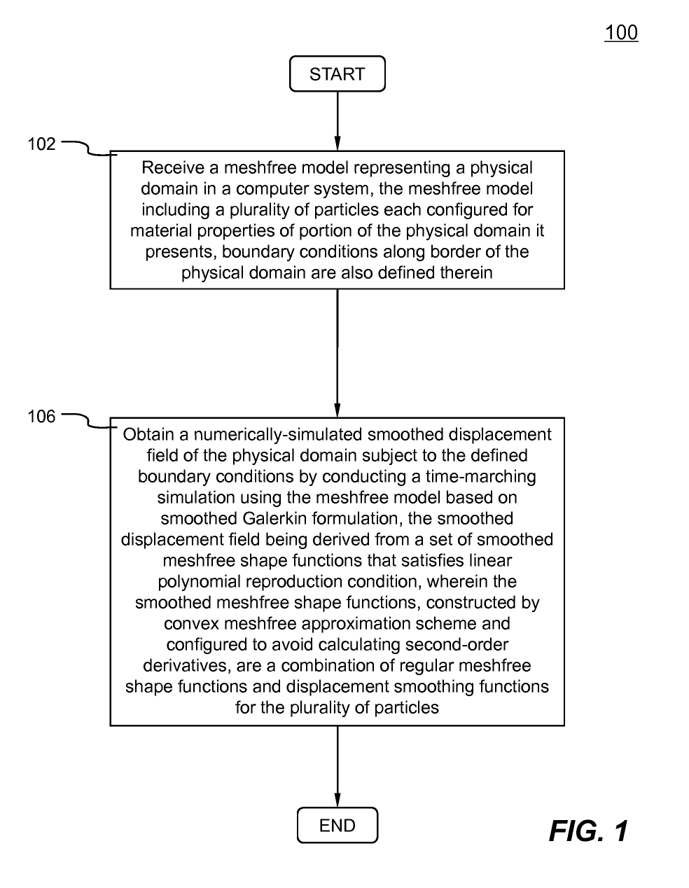

Referring first to FIG. 1, a flowchart illustrating an exemplary process 100 of obtaining numerically-simulation displacement field of a physical domain based on smoothed particle Galerkin formulation. Process 100 is preferably implemented in software and understood with other figures.

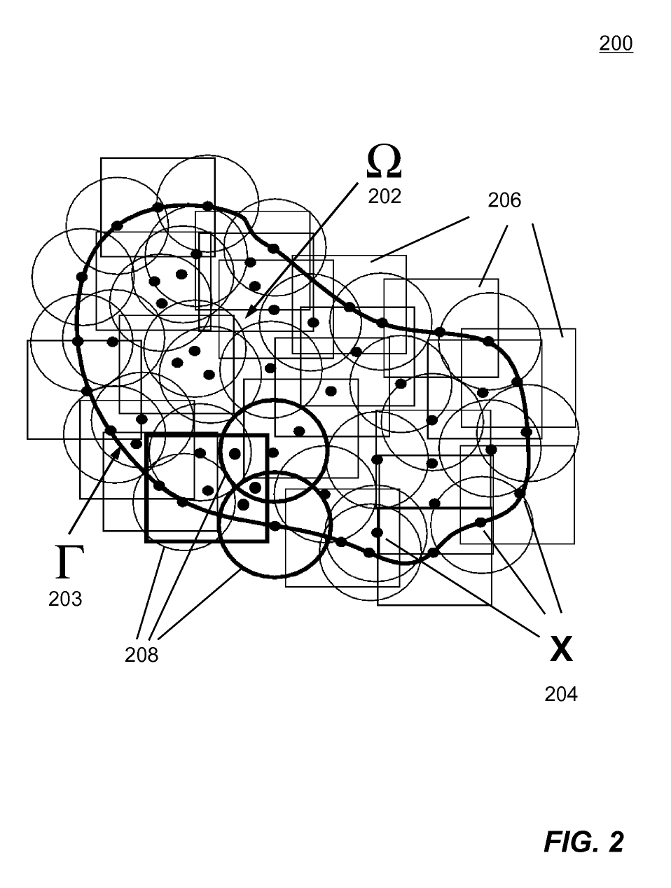

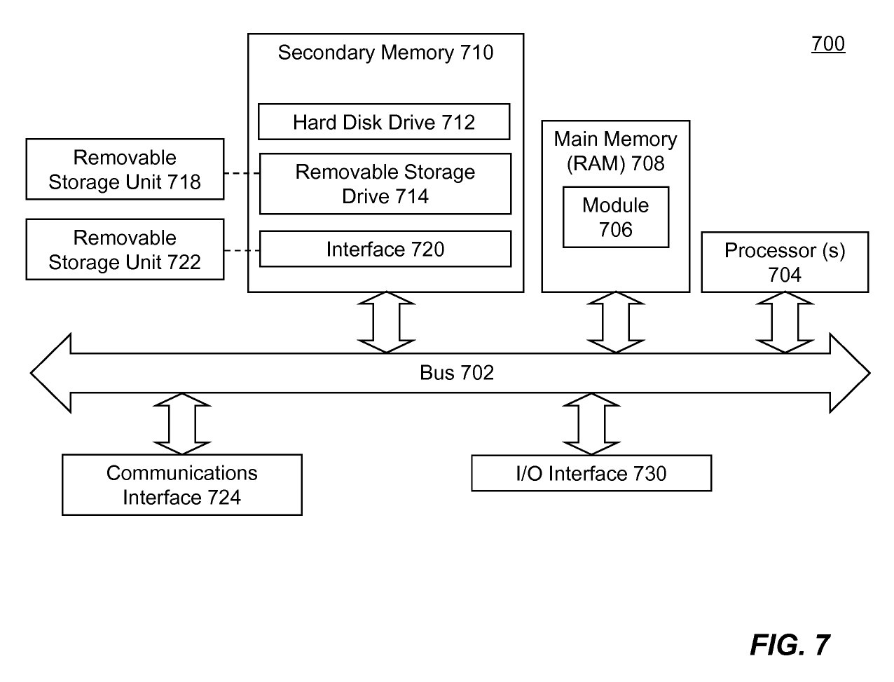

Process 100 starts at step 102 by receiving a meshfree model represent a physical domain in a computer system (e.g., computer 700 of FIG. 7) having an application installed thereon. The application module is configured to perform a time-marching simulation based on smoothed particle Galerkin formulation. The meshfree model comprises a number of particles with each particle being configured to represent portion of the physical domain's material properties. An exemplary meshfree model 200 is shown in FIG. 2

An exemplary physical domain Ω202 and the corresponding boundary or border Γ203 are depicted. To represent the physical domain 202, a plurality of particles 204 are used. The particles 204 representing the physical domain 202 do not have a particular pattern. They may be regularly spaced or arbitrarily located. These particles may be located in the interior or on the border 203 of the physical domain 202. Each of the particles 204 contains a domain of influence or support 206 and 208. The domain of influence and the support are used interchangeably hereinafter. The size and shape of the support for each particle are also arbitrary. In one embodiment, the shape of the support is quadrilateral 206. In another embodiment, the shape is circular 208. In the case of three-dimensional support, the shape of the support may be spherical in that embodiment. In yet another embodiment, the size and the shape of each particle are different. One particle may have a one square foot support while another particle may have a 16-in radius circular support in the same model. In yet another embodiment, the support is not a regular geometric shape. It can be any arbitrary shape. The present invention can support all different combinations.

In addition, boundary conditions are defined on the border 203 of the physical domain 202 in the meshfree model.

The static structural behaviors of an elastic body under plain strain conditions is derived in the following manners. A physical domain Ψ⊂ [symbol] is defined as a bounded polygon with the smooth boundary Γ=∂Ω. Also, let u be the displacement and further assume that the Dirichlet boundary conditions are applied on Γ_{D} and the Neumann boundary conditions are prescribed on Γ_{N}. For a prescribed body force f(X) ∈ L²(Ω), the governing equilibrium equation and boundary conditions are written as

−∇·σ(u)=f in Ω

u=g on Γ_{D}

σ·n=t on Γ_{N} (1)

### (Γ_{N}∪Γ_{N}=Γ; Γ_{D}∩Γ_{N}=Ø

where g is the prescribed displacement on Γ_{D}, t is the prescribed traction, n is the outward unit normal to the boundary Γ_{N} and ∇19 stands for the divergence operator.

The infinitesimal strain tensor ε(u) is defined by

ε(u)=½(∇u+(∇u)^{T})≡∇^{s}u (2)

where ∇ is the gradient operator. In the case of linear isotropic elasticity, the Cauchy stress tensor σ and strain tensor ε have the following relationship

σ=Cε(u)=2με(u)+λtr(ε(u))I (3)

where C is the fourth-order elasticity tensor and I is the identity tensor. The positive constants μ and λ the Lamé constants such that μ ∈ [μ₁/μ₂] with 0<μ₁<μ₂ and λ ∈ (0, ∞). The Lamé constants can be related to the Young's modulus E and Poisson ratio v by

$$μ = \frac{E}{2 ( 1 + v )} , λ = \frac{vE}{( 1 + v ) ( 1 - 2 v )} \qquad ( 4 )$$

Referring back to FIG. 1, at step 106, numerically-simulated displacement field of the physical domain subject to the defined set of boundary conditions is then obtained by conducting a time-marching simulation using the meshfree model based on smoothed particle Galerkin formulation. The smoothed displacement field (i.e., ū(X) of Eq. (13)) is derived from a set of smoothed meshfree shape functions (i.e., φ_{K}(X₁) of Eq. (26)) that satisfies linear polynomial reproduction condition. The set of smoothed meshfree shape functions is constructed by convex meshfree approximation scheme and configured to avoid calculating second-order derivatives. Additionally, the set of smoothed meshfree shape functions is created with a combination of a set of regular meshfree shape functions (i.e., ψ₁(X)of Eq.(26)) and a set of displacement smoothing functions (i.e., \tilde{Ψ}_{J}(X₁) of Eq. (26)) for the plurality of particles defined in the meshfree model.

The second-order derivatives (e.g., second term in Eq. (20)) are results of solving the smoothed displacement field directly from unknown generalized displacement field.

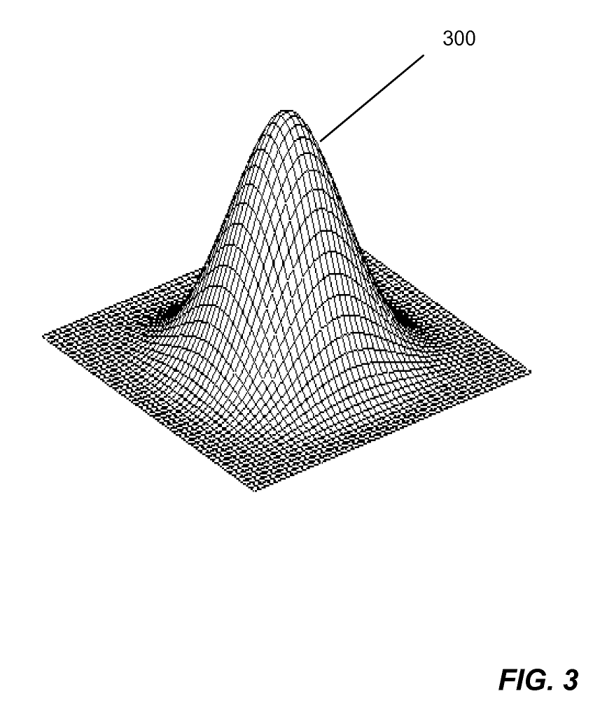

An exemplary regular meshfree shape function 300 is graphically shown in FIG. 3. In one embodiment, the set of regular meshfree shape functions and the set of displacement smoothing functions are the same.

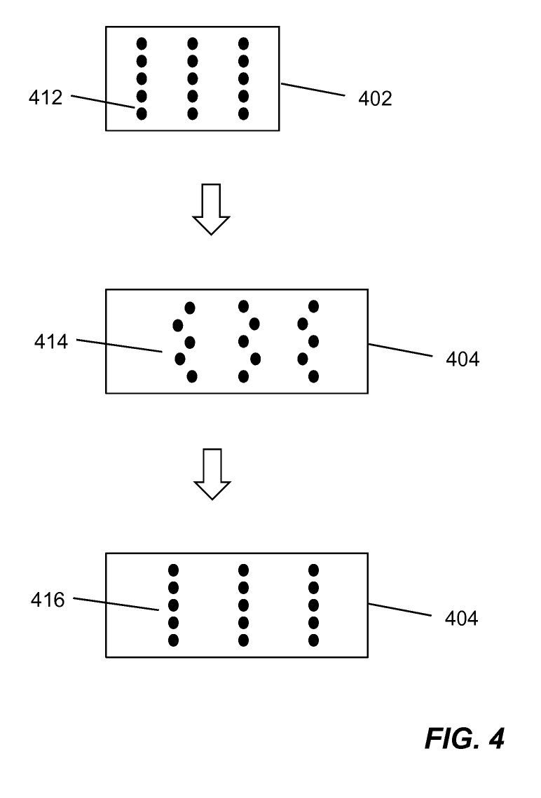

To further demonstrate smoothed displacement field of a physical domain 402, an example is shown in FIG. 4. Physical domain 402 is represented by a set of particles 412. The original physical domain 402 is stretched to become deformed (stretched) physical domain 404. However, due to under integration thereby zero energy modes, the particles are deformed in a non-uniform manner 414, which are the raw displacement field (containing numerical errors not realistic). In one embodiment, a smoothed displacement field 416 is obtained instead (realistic).

The variational form of this problem is to find the displacement u ∈ V^{g}={v ∈ H¹(Ω): v=g on Γ_{D}} such that for all δu ∈ V

∫_{Ω}δ∇^{s}(u): C∇^{s}(u)dΩ−∫_{Ω}δu·fdΩ−∫_{Γ}_{_{N}}δu·tdΓ=0 (5)

where the space V=H¹ (Ω) consists of functions in Sobolev space H¹ (Ω) which vanishes on the boundary in the sense of traces and is defined by

V(Ω)={v:v ∈ H¹, v=0 on Γ_{D}} (6)

By the Lax-Milgram theorem, there exists a unique solution u ∈ V^{g} to the problem. Moreover, let

$$u ∈ {V}^{g} ⋂ {H}^{2} ( f ∈ {L}^{2} ( Ω ) , g = {w}_{1} {\vert}_{{Γ}_{D}}$$

where w₁ ∈ H² (Ω), and

$$t = {w}_{2} {\vert}_{{Γ}_{N}}$$

where w₂ ∈ H¹ (Ω)) , we have the following elliptic regularity estimate for the two-dimensional linear elasticity posed in a convex domain with a polygonal boundary:

∥u∥₂+λ∥∇·u∥₁≦C₁(∥f∥₀+∥w₁∥₂+∥w₂∥₁) (7)

where ∥·∥ₘ is Sobolev norm of order m as defined in a standard way. The constant C₁ in Eq. (7) does not depend on λ and μ.

For simplicity, we assume the homogenous Dirichlet boundary conditions in the following derivation. The standard meshfree Galerkin method is then formulated on a finite dimensional subspace V^{h} ⊂ V employing the variational formulation of Eq. (5) to find u^{h} ∈ V ^{h} such that

δΠ=∫_{Ω}δ∇^{s}(u^{h}):C∇^{s}(u^{h})dΩ−∫_{Ω}δu^{h}·fdΩ−∫_{Γ}_{_{N}}δu^{h}·tdΓ=0∀δu^{h} ∈ V^{j} (8)

### A Smoothed Particle Galerkin Formulation for Linear Elasticity

Derivation of smoothed particle Galerkin formulation for the analysis of linear elasticity problem using a direct nodal integration scheme is presented below. For a particle distribution noted by an index set Z₁={X_{I}}_{I=1}^{NP}, we approximate the displacement field using the meshfree approximation constructed by either conventional meshfree approximation methods or convex approximation methods to give

$${u}^{h} ( X ) = {\sum }_{I = 1}^{NP} {Ψ}_{I} ( X ) {\tilde{u}}_{I} ≡ \hat{u} ( X ) ∀ X ∈ Ω \qquad ( 9 )$$

where NP is the total number of particles, and Ψ₁(X), I=1, . . . NP can be considered as the shape functions of the meshfree approximation for displacement field u^{h} (X). With the meshfree shape functions, we can define the corresponding finite-dimensional approximation space to be V^{h}=span {Ψ₁(X): I ∈ Z₁ and X ∈ Ω}. In general, ũ_{I} is not the particle displacement and is often referred to as the “generalized” displacement of particle I in meshfree Galerkin method. Using Eq. (9), the particle displacement at particle I can be expressed by

$${u}^{h} ( {X}_{I} ) = {\sum }_{J = 1}^{NP} {Ψ}_{J} ( {X}_{I} ) {\tilde{u}}_{J} ≡ {\hat{u}}_{I} \qquad ( 10 )$$

where X_{I}=(X_{I}, Y_{I}) is the nodal coordinate of particle I. If the meshfree shape functions Ψ₁(X) are constructed using a convex approximation, then they have the Kronecker-delta property on the boundary, i.e. û₁ =ũₗ ∀X₁ ∈ Γ.

According to one embodiment, the first-order convex approximation is constructed by the GMF method using the inverse tangent basis function and the cubic spline window function. Giving a convex hull Convex(Z ₁) of the node set Z₁={X₁, I=1, . . . NP} ∈ [symbol] defined by

$$Convex ( {Z}_{I} ) = \{ {\sum }_{I = 1}^{NP} {α}_{I} {X}_{I} \vert {α}_{I} ∈ , {\sum }_{I = 1}^{NP} {α}_{I} = 1 , {α}_{I} \geq 0 , {X}_{I} ∈ {Z}_{I} \} \qquad ( 11 )$$

the GMF method is used to construct a convex approximation of a given (smooth) function u(X)in the form of Eq. (9) such that the shape function Ψ₁: Convex (Z₁)→ [symbol] satisfies the following linear polynomial reproduction property

$${\sum }_{I = 1}^{NP} {Ψ}_{I} ( X ) {X}_{I} = X ∀ X ∈ Convex ( {Z}_{I} ) \qquad ( 12 )$$

With the meshfree convex approximation, we can also define a H₀¹—conforming subspace for the approximation of displacement field to be V^{h}:=span {Ψ₁|(supp Ψ_{I})⁰ ⊂ Ω, I ∈ Z_{I}}. An evaluation of weak form in Eq. (8) using meshfree approximation and direct nodal integration scheme leads to the spurious, or zero-energy, modes. This is a consequence of the fact that field variables and their derivatives are calculated at the same points such that an alternating field variable has a zero gradient at particles. The almost vanishing first derivatives at the nodes result in a discrete weak form that does not adequately reflect the strain energy and its contribution to the stiffness matrix is severely underestimated. In order to eliminate the presence of spurious or zero-energy modes caused by the direct nodal integration scheme, the smoothed particle Galerkin method introduces the smoothing of the displacement field defined by

ū(X)=∫_{Ω}\tilde{Ψ}(Y; X)û(Y)d/Ω (13)

where Y denotes the position of the infinitesimal volume dΩ. The discrete form of Eq. (13) becomes

$${\overline{u}}_{I} = {\sum }_{J = 1}^{NP} {\tilde{Ψ}}_{J} ( {X}_{I} ) {\hat{u}}_{J} \qquad ( 14 )$$

where \tilde{Ψ}_{J}(X₁), J=1, . . . NP are the displacement smoothing functions for particle I. It is assumed that the displacement smoothing functions \tilde{Ψ} also satisfy the linear polynomial reproduction condition. In other words, the smoothed displacement field ū(X)equals to û(X) for homogeneous displacement states.

For sufficiently smoothed displacement field û(X), the integral form in Eq. (13) can be expressed in terms of gradients of û(X) by expanding ū(X) into a Taylor series to yield

$$\hat{u} ( Y ) = \hat{u} ( X ) + ∇ \hat{u} ( X ) ( Y - X ) + \frac{1}{2 !} {∇}^{( 2 )} \hat{u} ( X ) {( Y - X )}^{( 2 )} + \frac{1}{3 !} {∇}^{( 3 )} \hat{u} ( X ) {( Y - X )}^{( 3 )} + … \qquad ( 15 )$$

where ∇⁽ⁿ⁾ denotes the nth order gradient operator.

Substituting Eq. (15) into Eq. (13) leads to the following smoothed displacement field in terms of gradients

$$\overline{u} ( X ) = {\int }_{Ω}^{ } \tilde{Ψ} ( Y ; X ) \hat{u} ( X ) d Ω + {\int }_{Ω}^{ } \tilde{Ψ} ( Y ; X ) ∇ \hat{u} ( X ) ( Y - X ) d Ω + \frac{1}{2 !} {\int }_{Ω}^{ } \tilde{Ψ} ( Y ; X ) {∇}^{( 2 )} \hat{u} ( X ) {( Y - X )}^{( 2 )} d Ω + \frac{1}{3 !} {\int }_{Ω}^{ } \tilde{Ψ} ( Y ; X ) {∇}^{( 3 )} \hat{u} ( X ) {( Y - X )}^{( 3 )} d Ω + {O ( ‖ Y - X ‖ )}^{( 4 )} \qquad ( 16 )$$

Truncating the Taylor series in Eq. (16) after the quadratic term and using the linear polynomial reproduction condition of displacement smoothing functions \tilde{Ψ} leads to

$$\begin{matrix}\overline{u} ( X ) \approx {\int }_{Ω}^{ } \tilde{Ψ} ( Y ; X ) \hat{u} ( X ) d Ω + {\int }_{Ω}^{ } \tilde{Ψ} ( Y ; X ) ∇ \hat{u} ( X ) \cdot \\ ( Y - X ) d Ω + \\ \frac{1}{2 !} {\int }_{Ω}^{ } \tilde{Ψ} ( Y ; X ) {∇}^{( 2 )} \hat{u} ( X ) {\cdot }^{( 2 )} {( Y - X )}^{( 2 )} d Ω \\ = \hat{u} ( X ) {\int }_{Ω}^{ } \tilde{Ψ} ( Y ; X ) d Ω + ∇ \hat{u} ( X ) ( \begin{matrix}{\int }_{Ω}^{ } \tilde{Ψ} ( Y ; X ) ( Y ) d Ω - \\ X {\int }_{Ω}^{ } \tilde{Ψ} ( Y ; X ) d Ω\end{matrix} ) + \\ {∇}^{( 2 )} \hat{u} ( X ) {\cdot }^{( 2 )} ( \frac{1}{2 !} {\int }_{Ω}^{ } \tilde{Ψ} ( Y ; X ) {( Y - X )}^{( 2 )} d Ω ) \\ = \hat{u} ( X ) {\int }_{Ω}^{ } \tilde{Ψ} ( Y ; X ) d Ω + \\ {∇}^{( 2 )} \hat{u} ( X ) {\cdot }^{( 2 )} ( \frac{1}{2 !} {\int }_{Ω}^{ } \tilde{Ψ} ( Y ; X ) {( Y - X )}^{( 2 )} d Ω ) \\ = \hat{u} ( X ) + {∇}^{( 2 )} \hat{u} ( X ) {\cdot }^{( 2 )} η ( X )\end{matrix} \qquad ( 17 )$$

with

$$η ( X ) = \frac{1}{2 !} {\int }_{Ω}^{ } \tilde{Ψ} ( Y ; X ) {( Y - X )}^{( 2 )} d Ω$$

defines the position dependent coefficient. In nodal integration, |η(X₁)|∝h² that is proportional to a length squared where h denotes a characteristic length scale of the discretization. Note that with convex approximation, we have η(X_{I})=0 and ū(X_{I})=û(X_{I}) for X_{I} on Γ.

The corresponding smoothed strain field can also be approximated using Eq. (17) to give

ε̅(X)=\hat{ε}(X)+∇\hat{ε}(X)·⁽²⁾∇η(X)+∇⁽²⁾\hat{ε}(X)·⁽²⁾η(X) (18)

With the smoothed strain derived from smoothed displacement field in Eq. (13), a modified weak form is obtained by neglecting the higher-order gradient terms in strains to find û ∈ V^{h}, such that

$$\begin{matrix}{a}^{h} ( \hat{u} , δ \hat{u} ) = l ( δ \hat{u} ) ∀ δ \hat{u} ∈ {V}^{h} & ( 19 ) \\ where & \\ \begin{matrix}{a}^{h} ( \hat{u} , δ \hat{u} ) = {\int }_{Ω}^{ } δ {∇}^{s} ( \hat{u} ) \text{:} C {∇}^{s} ( \hat{u} ) d Ω + \\ {\int }_{Ω}^{ } {( ∇ η \text{:} δ ∇ \hat{ɛ} ( X ) )}^{T} \text{:} C ( ∇ η \text{:} ∇ \hat{ɛ} ( X ) ) d Ω \\ = {a}_{stan}^{h} ( \hat{u} , δ \hat{u} ) + {a}_{stab}^{h} ( \hat{u} , δ \hat{u} )\end{matrix} & ( 20 ) \\ l ( δ \hat{u} ) = {\int }_{Ω}^{ } δ \hat{u} \cdot fd Ω + {\int }_{{Γ}_{N}}^{ } δ \hat{u} \cdot t d Γ - {\int }_{Ω}^{ } η \text{:} δ {∇}^{( 2 )} \hat{u} \cdot f d Ω & ( 21 )\end{matrix}$$

where aₛₜₐₙ^{h} is the standard bilinear form defined in Eq. (8) and

$$\begin{matrix}{a}_{stab}^{h} ( \hat{u} , δ \hat{u} ) = {\int }_{Ω}^{ } {( ∇ η \text{:} δ ∇ \hat{ɛ} ( X ) )}^{T} \text{:} C ( ∇ η \text{:} ∇ \hat{ɛ} ( X ) ) d Ω \\ {\int }_{Ω}^{ } {( ∇ η \text{:} δ {∇}^{( 2 )} \hat{u} ( X ) )}^{T} \text{:} C ( ∇ η \text{:} {∇}^{( 2 )} \hat{u} ( X ) ) d Ω\end{matrix} \qquad ( 22 )$$

defines the stabilized bilinear form which corresponds to the variation of stabilized potential energy. The stabilization terms containing first derivatives of displacements are also omitted in Eq. (20) by considering their zero gradients at the particles.

In standard isotropic linear elastic case, coercivity of the bilinear form a^{h}(·,·) on V^{h}×V^{h} follows immediately from one of Korn's inequalities to give

$${‖ \hat{u} ‖}_{1}^{2} \leq {c}_{1} {‖ \hat{ɛ} ‖}_{0}^{2} \leq {c}_{1} ( {‖ \hat{ɛ} ‖}_{0}^{2} + {‖ ∇ η \text{:} ∇ \hat{ɛ} ‖}_{0}^{2} ) \leq \frac{{c}_{1}}{{γ}_{m i n} ( C )} ( {a}_{stan}^{h} ( \hat{u} , \hat{u} ) + {a}_{stab}^{h} ( \hat{u} , \hat{u} ) ) = {c}_{2} {a}^{h} ( \hat{u} , \hat{u} ) , {c}_{1} , {c}_{2} > 0 , \hat{u} ∈ {V}^{h} \qquad ( 23 )$$

where γₘᵢₙ is the smallest eigenvalue of C.

Using Cauchy-Schwarz inequality and first-order meshfree interpolation property for the displacement smoothing function \tilde{Ψ}, a^{h}(·,·) also can be bounded by

$$\vert {a}^{h} ( \hat{u} , \hat{v} ) \vert \leq {\int }_{Ω}^{ } \vert {∇}^{s} ( \hat{u} ) \text{:} C {∇}^{s} ( \hat{v} ) \vert d Ω + {\int }_{Ω}^{ } \vert {( ∇ η \text{:} ∇ \hat{ɛ} ( X ) )}^{T} C \text{:} ( ∇ η \text{:} ∇ \hat{ɛ} ( X ) ) \vert d Ω \leq {γ}_{ma x} ( C ) \{ {( {\int }_{Ω}^{ } {‖ \hat{ɛ} ( \hat{u} ) ‖}_{0}^{2} d Ω )}^{1 / 2} + {( {\int }_{Ω}^{ } {‖ \hat{ɛ} ( \hat{v} ) ‖}_{0}^{2} d Ω )}^{1 / 2} + {{c}_{3} ( {\int }_{Ω}^{ } {‖ h ∇ \hat{ɛ} ( \hat{u} ) ‖}_{0}^{2} d Ω )}^{1 / 2} + {( {\int }_{Ω}^{ } {‖ h ∇ \hat{ɛ} ( \hat{v} ) ‖}_{0}^{2} d Ω )}^{1 / 2} \} \leq {γ}_{ma x} ( C ) {c}_{4} \{ {\vert \hat{u} \vert}_{1} {\vert \hat{v} \vert}_{1} \} \leq {c}_{5} {‖ \hat{u} ‖}_{1} {‖ \hat{v} ‖}_{1} , {c}_{3} , {c}_{4} , {c}_{5} > 0 ∀ \hat{u} , \hat{v} ∈ {V}^{h} \qquad ( 24 )$$

where γₘₐₓ is the largest eigenvalue of C. The third inequality is obtained using a simple triangle inequality for the strain component of norm ∥\hat{ε}(û)∥₀ defined in L² space.

Since Eq. (22) includes non-zero second derivatives of the displacements, it serves as a stabilization term and appears like the least-square stabilization method for the nodal integration in the Element-Free Galerkin method. The numerical evaluation of Eq. (19) using direct nodal integration results in a symmetric stiffness matrix. Compared to the least-square stabilization method, the stabilization parameter in Eq. (22) is derived in a consistent manner without additional prescription of its value. However the integration of Eq. (22) involves second derivatives and is expensive for the assembly of linear systems in multi-dimensional problems.

According to one embodiment, an alternative way to implement the smoothed displacement field in Eq. (8) without the involvement of second-order derivatives in shape functions is introduced. This is to use the integral form in Eq. (13) instead of gradient form in Eq. (17). By substituting Eq. (10) into Eq. (14), we have the discrete smoothed displacement field evaluated at particles by

$$\begin{matrix}{\overline{u}}_{I} = {\sum }_{J = 1}^{NP} {\tilde{Ψ}}_{J} ( {X}_{I} ) {\hat{u}}_{J} \\ = {\sum }_{J = 1}^{NP} {\tilde{Ψ}}_{J} ( {X}_{I} ) {\sum }_{K = 1}^{NP} {Ψ}_{K} ( {X}_{J} ) {\tilde{u}}_{K} \\ = {\sum }_{K = 1}^{NP} {\sum }_{J = 1}^{NP} {Ψ}_{K} ( {X}_{J} ) {\tilde{Ψ}}_{J} ( {X}_{I} ) {\tilde{u}}_{K} \\ = {\sum }_{K = 1}^{NP} {φ}_{K} ( {X}_{I} ) {\tilde{u}}_{K}\end{matrix} \qquad ( 25 )$$

where the smoothed meshfree shape function φ_{K} (X_{I}) is defined by

$${φ}_{K} ( {X}_{I} ) := {\sum }_{J = 1}^{NP} {Ψ}_{K} ( {X}_{J} ) {\tilde{Ψ}}_{J} ( {X}_{I} ) \qquad ( 26 )$$

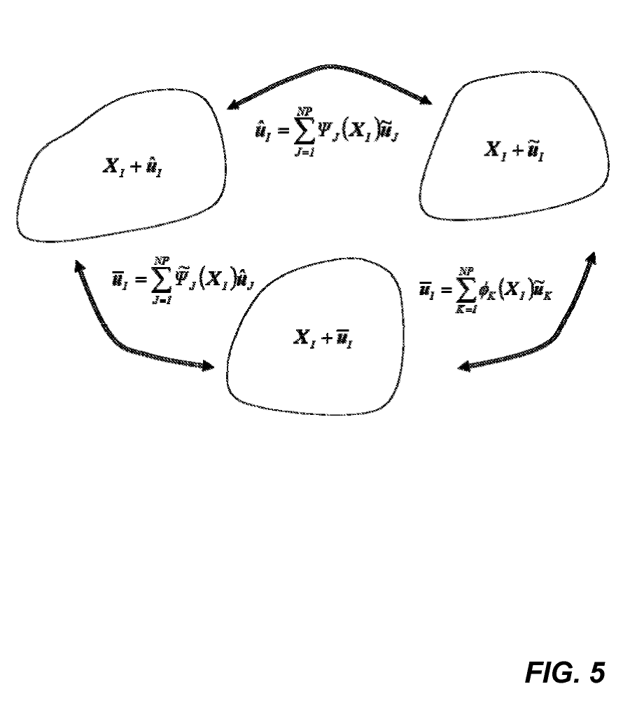

Now the relationship between different nodal position systems can be defined through Eqs. (10), (14) and (25) and is shown in FIG. 5.

There is no difficulty to prove that the smoothed meshfree shape functions verify the following partition of unity and linear polynomial reproduction properties:

$$\begin{matrix}{\sum }_{J = 1}^{NP} {φ}_{J} ( {X}_{I} ) = 1 ∀ {X}_{I} ∈ Ω & ( 27 ) \\ {\sum }_{J = 1}^{NP} {φ}_{J} ( {X}_{I} ) {X}_{J} = {X}_{I } ∀ {X}_{I} ∈ Ω & ( 28 ) \\ {\sum }_{J = 1}^{NP} {φ}_{J} ( {X}_{I} ) {Y}_{J} = {Y}_{I } ∀ {X}_{I} ∈ Ω & ( 29 )\end{matrix}$$

In particular, the smoothed meshfree shape function constructed by the meshfree convex approximation continues to satisfy the Kronecker-delta property on the boundary,

$${φ}_{K} ( {X}_{I} ) = {\sum }_{J = 1}^{NP} {Ψ}_{K} ( {X}_{J} ) {\tilde{Ψ}}_{J} ( {X}_{I} ) = {δ}_{KI} ∀ {X}_{K} ∈ {Γ}_{g} \qquad ( 30 )$$

Using Eq. (9), we have the admissible test functions for the variation equation obtained by

$$δ {u}^{h} ( X ) = {\sum }_{I = 1}^{NP} {Ψ}_{I} ( X ) δ {\tilde{u}}_{I} \qquad ( 31 )$$

The strains can also be approximated by

$$ɛ ( {u}^{h} ) = {\sum }_{I = 1}^{NP} {B}_{I} {\tilde{u}}_{I} \qquad ( 32 )$$

where B_{I} is the standard gradient matrix given by

$${B}_{I} ( X ) = [ \begin{matrix}{Ψ}_{I , X} ( X ) & 0 \\ 0 & {Ψ}_{I , Y} ( X ) \\ {Ψ}_{I , Y} ( X ) & 0 \\ 0 & {Ψ}_{I , X} ( X )\end{matrix} ] \qquad ( 33 )$$

By introducing the displacement and strain approximations into Eq. (8), the following discrete governing equation is integrated using a direct nodal integration to give

$$\begin{matrix}δ {\tilde{U}}^{T} K \tilde{U} = δ {\tilde{U}}^{T} {f}^{ext} & ( 34 ) \\ {K}_{IJ} = \int {B}_{I}^{T} {CB}_{J} d Ω = {\sum }_{K = 1}^{NP} {B}_{I}^{T} ( {X}_{K} ) {CB}_{J} ( {X}_{K} ) {V}_{K}^{0} & ( 35 ) \\ \begin{matrix}{f}_{I}^{ext} = {\int }_{Ω} {Ψ}_{I} f d Ω + {\int }_{{Γ}_{N}} {Ψ}_{I} t d Γ \\ = {\sum }_{K = 1}^{NP} {Ψ}_{I} ( {X}_{K} ) f ( {X}_{K} ) {V}_{K}^{0} + {\sum }_{K = 1}^{NB} {Ψ}_{I} ( {X}_{K} ) t ( {X}_{K} ) {L}_{K}\end{matrix} & ( 36 )\end{matrix}$$

where V_{K}⁰ denotes the initial volume of particle K. The initial particle volume can be obtained using the method of the Voronoi diagram or simply by performing the area integration using a finite element mesh. The use of non-negative and exactly reproducing affine functions in the convex approximation will guarantee the conservation of total mass and the positivity of the particle volume. In Eq. (36) NB denotes the number of boundary nodes and Lₖ is the length associated with the boundary particle along the global boundary.

To explore the concept of the method as well as to improve computational efficiency, we simply consider \tilde{Ψ}_{I}(X)=Ψ_{I}(X). From Eq. (14), we have

$${\overline{u}}_{I} = {\sum }_{K = 1}^{NP} {Ψ}_{K} ( {X}_{J} ) {\sum }_{J = 1}^{NP} {Ψ}_{J} ( {X}_{I} ) {\tilde{u}}_{K} = {\sum }_{K = 1}^{NP} {φ}_{K} ( {X}_{I} ) {\tilde{u}}_{K} \qquad ( 37 )$$

or in matrix form

Ū=AŨ or Ũ=A⁻¹U (38)

where vector Ũ=[ũ₁, ũ₂, . . . , ũ_{NP}] contains the problem unknowns for generalized nodal displacements. A is a transformation matrix defined by

$${A}_{IJ} = {φ}_{J} ( {X}_{I} ) I = {\sum }_{K = 1}^{NP} {Ψ}_{K} ( {X}_{I} ) {Ψ}_{J} ( {X}_{K} ) I \qquad ( 39 )$$

Substituting the variation form of Eq. (38) into Eq. (34) leads to the following discrete equation to be solved for the linear elastic analysis

A^{-T}KA⁻¹Ū=A^{-T}f^{ext} (40)

or equivalently

A^{-T}KŨ=A^{-T}f^{ext} (41)

Eq. (40) and Eq. (41) are identical but they are expressed in different forms for the purposes of implementation. Eq. (40) results in a symmetric stiffness matrix which requires less memory storage and is available for a sparse direct symmetric solver. However, Eq. (41) allows a convenient way to enforce the discrete Dirichlet boundary conditions using Eq. (21), and thus is more favorable than Eq. (40) in terms of implementation.

### Large Deformation Quasi-Static Analysis for Inelastic Material

The smoothed meshfree Galerkin formulation presented in previous section is now extending to the nonlinear analysis of plasticity. In light of the rate constitutive equations and the derivatives with respect to spatial coordinates, it is advantageous to use the variational formulation of the equation of motion in terms of updated Lagrangian formulation in the following derivation.

In the quasi-static problem, the variational formulation of the updated Lagrangian formulation with reference to the current configuration Ωₓ is expressed in an index form by

δΠ=∫_{Ω}_{ₓ}δεᵢⱼσᵢⱼdΩ−∫_{Ω}_{ₓ}δuᵢfᵢdΩ−∫_{Γ}_{_{N}}δuᵢtᵢdΓ=0 (42)

where σᵢⱼ is the Cauchy stress defined at the current configuration. We also have x₁=Xᵢ+uᵢ that relates the spatial coordinate x to the reference coordinate X.

Linearizing Eq. (42) leads to the iterative equations

ΔδΠ=∫_{Ω}_{ₓ}δεᵢⱼCᵢⱼₖₗΔεₖₗdΩ+∫_{Ω}_{ₓ}δu_{i,j}TᵢⱼₖₗΔu_{k,l}dΩ−−∫_{Ω}_{ₓ}δuᵢΔfᵢdΩ−∫_{Γ}_{_{N}}δuᵢΔtᵢdΓ (43)

where

Cᵢⱼₖₗ=Cᵢⱼₖₗ^{alg}−Cᵢⱼₖₗ* (44)

Cᵢⱼₖₗ*=−σⱼₗδik+½(σᵢₗδⱼₖ+σⱼₗδᵢₖ+σᵢₖδⱼₗ+σⱼₖδᵢₗ) (45)

Tᵢⱼₖₗ=δᵢₖσⱼₗ (46)

Cᵢⱼₖₗ is the material tangent response tensor, Cᵢⱼₖₗ^{alg} is the algorithmic tangent response tensor for the infinitesimal plasticity. Substituting the discrete meshfree approximation in Eq. (31) and its variation into Eq. (43) leads to the discrete iterative equation given by

δŨ^{T}Kₙ₊₁^{v}(ΔŨ)ₙ₊₁^{v+1}=δŨ^{T}Rₙ₊₁^{v} (47)

The notation ()ₙ₊₁^{v} represents the function to be computed in the v-th iteration during (n+1)th time incremental step. Using Eq. (38), the discrete iterative equation can be written in the smoothed nodal position system as in the linear analysis to yield

A^{-T}Kₙ₊₁^{v}A⁻¹(ΔŪ)ₙ₊₁^{v+1}=A^{-T}Rₙ₊₁^{v} (48)

or equivalently

A^{-T}Kₙ₊₁^{v}(ΔŨ)ₙ₋₁^{v+1}=A^{-T}Rₙ₊₁^{v} (49)

The enforcement of discrete Dirichlet boundary conditions is treated the same as in the linear analysis. In the context of the updated Lagrangian formulation, the meshfree shape functions and their derivatives constructed at spatial coordinates, i.e., Ψ_{I}(X) and ∂Ψ_{I}(X)/∂x I=1, . . . NP, are the natural choices for the updated Lagrangian formulation. On the other hand, one major defect of this choice is the lack of stability which resembles the tensile instability in SPH method associated with the adoption of an Eulerian kernel. To resolve this numerical issue, the meshfree shape functions are referenced to the material coordinates. Since the spatial coordinates x and material coordinates X are one-to-one mapping between each other within the Lagrangian description, the derivatives of material meshfree shape functions with respect to spatial coordinates can be carried out by chain rule to give

$${Ψ}_{I , i} ( X ) = \frac{\partial {Ψ}_{I} ( X ( x ) )}{\partial {x}_{i}} = \frac{\partial {Ψ}_{I} ( X )}{\partial {X}_{j}} \frac{\partial {X}_{j}}{\partial {x}_{i}} = \frac{\partial {Ψ}_{I}}{\partial {X}_{j}} {F}_{ji}^{- 1} \qquad ( 50 )$$

Accordingly, the volume integrals in Eq. (43) can be carried out in the reference configuration Ω_{X} by

∫_{Ω}_{ₓ}( )dΩ=∫_{Ω}_{ₓ}( )J₀dΩₓ (51)

where J₀=det(F) and F is the deformation gradient.

Employing the direct nodal integration in Eq. (43), the stiffness matrix K and the residual R can be expressed by

$$\begin{matrix}{K}_{IJ} = {\sum }_{N = 1}^{NP} {B}_{I}^{T} ( {X}_{N} ) {G}^{T} ( {X}_{N} ) [ C ( F ( {X}_{N} ) ) + T ( F ( {X}_{N} ) ) ] G ( {X}_{N} ) {B}_{J} ( {X}_{N} ) {J}_{0} ( {X}_{N} ) {V}_{N}^{0} & ( 52 ) \\ {R}_{I} = {f}_{I}^{est} - {f}_{I}^{int} \\ where & ( 53 ) \\ {f}_{I}^{int} = {\sum }_{N = 1}^{NP} {B}_{I}^{T} ( {X}_{N} ) {G}^{T} ( {X}_{N} ) S ( F ( {X}_{N} ) ) {J}_{0} ( {X}_{N} ) {V}_{N}^{0} & ( 54 ) \\ {f}_{I}^{ext} = {\sum }_{N = 1}^{NP} {Ψ}_{I} ( {X}_{N} ) f ( {X}_{N} ) {J}_{0} ( {X}_{N} ) {V}_{N}^{0} + {\sum }_{N = 1}^{NP} {Ψ}_{I} ( {X}_{N} ) t ( {X}_{N} ) {L}_{N} & ( 55 ) \\ G = [ \begin{matrix}{F}_{11}^{- 1} & 0 & {F}_{21}^{- 1} & 0 \\ 0 & {F}_{22}^{- 1} & 0 & {F}_{12}^{- 1} \\ {F}_{12}^{- 1} & {F}_{21}^{- 1} & {F}_{22}^{- 1} & {F}_{11}^{- 1}\end{matrix} ] & ( 56 ) \\ S = [ \begin{matrix}{σ}_{11} \\ {σ}_{22} \\ {σ}_{12}\end{matrix} ] & ( 57 )\end{matrix}$$

### Explicit Dynamic Formulation and Adaptive Lagrangian Kernel Approach for Severe Inelastic Deformation Analysis

It is known that a strictly or purely Lagrangian approach based on a fix mesh in finite element method experiences difficulties in dealing with mesh distortion problem in severe and unconstrained material flows. Although the present smoothed particle Galerkin method using the Lagrangian kernel helps reduce the mesh entanglement observed in the finite element method, it prohibits extending the range of the meshfree method to severe deformation problems that go beyond the Lagrangian description, i.e, the discretized deformation mapping ceases to be injective.

J₀=det(F(X_{J}))<0,X_{J} ∈ Z_{I} (58)

A negative Jacobian in the Lagrangian calculation leads to ill conditioning of the global stiffness matrix in quasi-static analysis and causes particle lockup and solution divergence. One way to sidestep this numerical difficulty is to consider the semi-Lagrangian kernel that was used in the Reproducing Kernel Particle method for the impact, penetration and earth moving simulations. Another way to evade the non-positive Jacobin determinant problem is to adopt an adaptive procedure similar to the combined rh-adaptive remeshing or global remeshing techniques in the finite element method. Although the adaptive remeshing method is able to refine the nodal density and generate accurate free surfaces for a better simulation in solid applications, the generation of a high quality mesh in severe deformed configuration is a challenge. In addition, the mesh-based adaptive solution requires a mapping procedure that transfers the solution variables between the old and new spatial discretization. This mapping procedure introduces errors and consumes extra computation time.

An analysis method switched from the quasi-static formulation to an explicit dynamic formulation is considered to avoid the convergence problem involving in the implicit analysis. Similar idea has been widely used in finite element commercial code for the large deformation analysis in solid mechanic applications. Additionally, an adaptive Lagrangian kernel approach is employed to overcome the numerical difficulty associated with the non-positive Jacobin determinant in the purely Lagrangian approach. Another advantage of using the adaptive Lagrangian kernel approach for the explicit dynamic analysis is the non-deteriorated critical time step in severe deformation according to the Courant-Friedrichs-Lewy (CFL) stability condition.

The explicit dynamic version of the smoothed particle Galerkin formulation can be easily obtained by considering the inertial effect and following the previous quasi-static derivation to yield

$${A}^{- T} {MA}^{- 1} \ddot{\overline{U}} = {A}^{- 1} ( {f}^{ext} - {f}^{int} ) \qquad ( 59 )$$

or equivalently

$${A}^{- T} M \ddot{\tilde{U}} = {A}^{- 1} ( {f}^{ext} - {f}^{int} ) \qquad ( 60 )$$

where [symbol] and [symbol] contains the vector of particle accelerations evaluated in the smoothed nodal position system and generalized nodal position system, respectively.

M is the consistent mass matrix given by

$${M}_{IJ} = {\sum }_{N = 1}^{NP} {ρ}_{0} {Ψ}_{I} ( {X}_{N} ) {Ψ}_{J} ( {X}_{N} ) {V}_{N}^{0} I \qquad ( 61 )$$

where ρ₀ is the initial density.

Since Eq. (59) is more convenient than Eq. (60) for an enforcement of essential boundary conditions in explicit dynamic analysis, it is implemented in an embodiment of the present invention. Eq. (59) also can rewritten as

$$\overline{M} \ddot{\overline{U}} = {A}^{- 1} ( {f}^{ext} - {f}^{int} ) \qquad ( 62 )$$

with M̅=A^{-T}MA⁻¹ defines a smoothed consist mass matrix.

In explicit dynamic analysis a row-sum mass matrix is usually considered which is only computed once without involving matrix inversion at each time step. The smoothed consist mass matrix is now replaced by the row-sum mass matrix M̅^{RS} to give

$${\overline{M}}_{I}^{RS} = {\sum }_{J}^{NP} {\overline{M}}_{IJ} = {\sum }_{J}^{NP} {A}_{IK}^{- T} {M}_{KM} {A}_{ML}^{- 1} \qquad ( 63 )$$

As Lagrangian simulation proceeds, an adaptive Lagrangian kernel scheme is performed frequently to avoid the negative Jacobian in the Lagrangian calculation. In each adaptive step material quantities are computed at particles without the usage of background cells. Since the adaptive Lagrangian kernel approach does not involve remeshing and particle computation is evaluated node-wise, the material quantities at all particles are maintained in the Lagrangian setting and thus require no remap procedures. If we denote the variables before and after the each adaptive time step to be superscripted with “−” and “+” respectively, the derivatives of material meshfree shape functions with respect to spatial coordinates right before (k+1)-th adaptive time step can be expressed by

$${Ψ}_{I , i}^{-} ( {x}^{k + 1} ) = \frac{\partial {Ψ}_{I}^{-} ( {x}^{k + 1} )}{\partial {x}_{i}^{k + 1}} = \frac{\partial {Ψ}_{I}^{-} ( {x}^{k + 1} )}{\partial {X}_{j}^{k}} \frac{\partial {x}_{j}^{k}}{\partial {x}_{j}^{k + 1}} = \frac{\partial {Ψ}_{I}^{-}}{\partial {x}_{j}^{k}} {f}_{ji}^{{k}^{- 1}} \qquad ( 64 )$$

where

$${f}_{ji}^{{k}^{- 1}} = \frac{\partial {x}_{j}^{k}}{\partial {x}_{j}^{k + 1}}$$

defines the inverse of incremental deformation gradient from k-th adaptive time step. At (k+1)-th adaptive time step, the new derivatives of material meshfree shape functions becomes

$${Ψ}_{I , i}^{+} ( {x}^{k + 1} ) = \frac{\partial {Ψ}_{I}^{+} ( {x}^{k + 1} )}{\partial {x}_{i}} \qquad ( 65 )$$

Since no remap procedures are considered in the adaptive Lagrangian kernel scheme, the particle mass is taken to be the same during the explicit dynamics analysis. The current particle volume required for the calculation of internal force is updated according to the continuity equation given by

$$\begin{matrix}{V}_{I} = \frac{{ρ}_{0}}{{ρ}_{I}} {V}_{I}^{0} & ( 66 ) \\ \frac{d {ρ}_{I}}{d t} = - {ρ}_{I} ∇ \cdot ( {\dot{\tilde{u}}}_{I} ) = - {ρ}_{I} {\sum }_{J = 1}^{NP} {\dot{\tilde{u}}}_{J} \cdot {Ψ}_{J , x} ( {x}_{I} ) & ( 67 )\end{matrix}$$

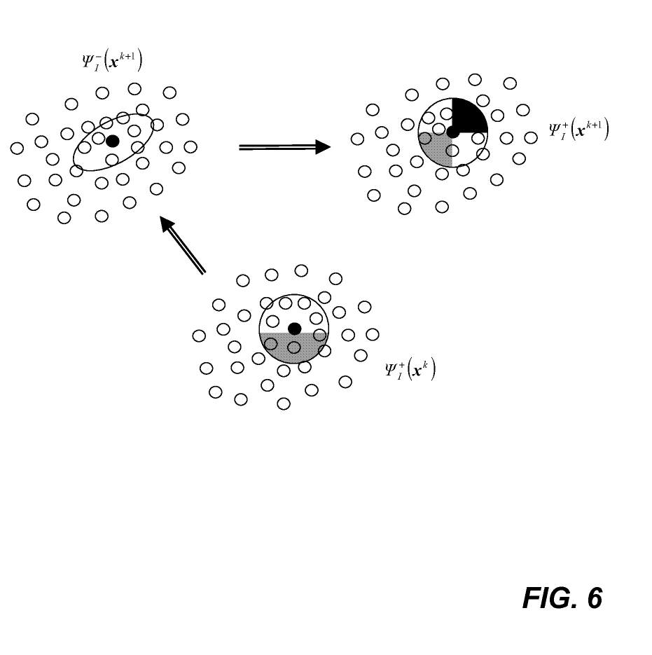

According to one embodiment of the present invention, initial support size of the kernel remains the same at each adaptive step, which is periodically taken by a constant time interval. FIG. 6 illustrates the evolution of Lagrangian kernel in one adaptive step.

The implementation of adaptive kernel scheme and explicit dynamic formulation in Eq. (59) or (60) acquires reconstruction of meshfree approximation frequently. Since the construction of meshfree convex approximation involves a solving of an iterative solution for a constrained minimization problem, it is not practical to perform a frequent adaptivity in explicit dynamic analysis due to the high computational cost. For that reason, only meshfree non-convex approximation is considered for the employment of adaptive Lagrangian kernel scheme in explicit dynamic analysis.

According to one aspect, the present invention is directed towards one or more computer systems capable of carrying out the functionality described herein. An example of a computer system 700 is shown in FIG. 7. The computer system 700 includes one or more processors, such as processor 704. The processor 704 is connected to a computer system internal communication bus 702. Various software embodiments are described in terms of this exemplary computer system. After reading this description, it will become apparent to a person skilled in the relevant art(s) how to implement the invention using other computer systems and/or computer architectures.

Computer system 700 also includes a main memory 708, preferably random access memory (RAM), and may also include a secondary memory 710. The secondary memory 710 may include, for example, one or more hard disk drives 712 and/or one or more removable storage drives 714, representing a floppy disk drive, a magnetic tape drive, an optical disk drive, etc. The removable storage drive 714 reads from and/or writes to a removable storage unit 718 in a well-known manner. Removable storage unit 718, represents a floppy disk, magnetic tape, optical disk, etc. which is read by and written to by removable storage drive 714. As will be appreciated, the removable storage unit 718 includes a computer readable medium having stored therein computer software and/or data.

In alternative embodiments, secondary memory 710 may include other similar means for allowing computer programs or other instructions to be loaded into computer system 700. Such means may include, for example, a removable storage unit 722 and an interface 720. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 722 and interfaces 720 which allow software and data to be transferred from the removable storage unit 722 to computer system 700. In general, Computer system 700 is controlled and coordinated by operating system (OS) software, which performs tasks such as process scheduling, memory management, networking and I/O services.

There may also be a communications interface 724 connecting to the bus 702. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc.

The computer 700 communicates with other computing devices over a data network based on a special set of rules (i.e., a protocol). One of the common protocols is TCP/IP (Transmission Control Protocol/Internet Protocol) commonly used in the Internet. In general, the communication interface 724 manages the assembling of a data file into smaller packets that are transmitted over the data network or reassembles received packets into the original data file. In addition, the communication interface 724 handles the address part of each packet so that it gets to the right destination or intercepts packets destined for the computer 700.

In this document, the terms “computer recordable storage medium”, “computer recordable medium” and “computer readable medium” are used to generally refer to media such as removable storage drive 714, and/or a hard disk installed in hard disk drive 712. These computer program products are means for providing software to computer system 700. The invention is directed to such computer program products.

The computer system 700 may also include an input/output (I/O) interface 730, which provides the computer system 700 to access monitor, keyboard, mouse, printer, scanner, plotter, and alike.

Computer programs (also called computer control logic) are stored as application modules 706 in main memory 708 and/or secondary memory 710. Computer programs may also be received via communications interface 724. Such computer programs, when executed, enable the computer system 700 to perform the features of the present invention as discussed herein. In particular, the computer programs, when executed, enable the processor 704 to perform features of the present invention. Accordingly, such computer programs represent controllers of the computer system 700.

In an embodiment where the invention is implemented using software, the software may be stored in a computer program product and loaded into computer system 700 using removable storage drive 714, hard drive 712, or communications interface 724. The application module 706, when executed by the processor 704, causes the processor 704 to perform the functions of the invention as described herein.

The main memory 708 may be loaded with one or more application modules 706 that can be executed by one or more processors 704 with or without a user input through the I/O interface 730 to achieve desired tasks. In operation, when at least one processor 704 executes one of the application modules 706, the results are computed and stored in the secondary memory 710 (i.e., hard disk drive 712). The status of the time-marching simulation (e.g., simulated displacement field, etc.) is reported to the user via the I/O interface 730 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas two-dimensional domain has been shown and described for illustrating simplicity, the present invention can be applied to a three-dimensional domain to accomplish the same. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of obtaining a smoothed displacement field of a physical domain based on smoothed particle Galerkin formulation in solid mechanics, the method comprising:
receiving, in a computer system having an application module installed thereon, a meshfree model representing a physical domain, the meshfree model including a plurality of particles, each configured for material properties of a portion of the physical domain, and a set of boundary conditions defined on the physical domain's border, wherein the application module is configured to perform a time-marching simulation based on smoothed particle Galerkin formulation; and
obtaining, by the application module, a numerically-simulated smoothed displacement field of the physical domain subject to the set of boundary conditions by conducting the time-marching simulation using the meshfree model, the smoothed displacement field being derived from a set of smoothed meshfree shape functions that satisfies linear polynomial reproduction condition, wherein the set of smoothed meshfree shape functions, constructed by a convex meshfree approximation scheme and configured to avoid calculating second-order derivatives, is created with a combination of a set of regular meshfree shape functions and a set of displacement smoothing functions for the plurality of particles.

2. The method of claim 1, further comprising establishing a domain of influence for each of the plurality of particles, the domain of influence being used for conducting the time-marching simulation more efficiently.

3. The method of claim 2, wherein the set of boundary conditions comprises Dirichlet boundary conditions for prescribed displacement and Neumann boundary conditions for prescribed traction.

4. The method of claim 2, wherein the convex meshfree approximation scheme ensures that the set of smoothed meshfree shape functions comprises Kronecker-delta property.

5. The method of claim 2, wherein the second-order derivatives are results of solving the smoothed displacement field directly from unknown generalized displacement field.

6. The method of claim 2, wherein the regular meshfree shape functions and the displacement smoothing functions are the same.

7. A system for obtaining a smoothed displacement field of a physical domain based on smoothed particle Galerkin formulation in solid mechanics, the system comprising:
a main memory for storing computer readable code for an application module configured to perform a time-marching simulation based on smoothed particle Galerkin formulation;
at least one processor coupled to the main memory, said at least one processor executing the computer readable code in the main memory to cause the application module to perform operations by a method of:
receiving a meshfree model representing a physical domain, the meshfree model including a plurality of particles, each configured for material properties of a portion of the physical domain, and a set of boundary conditions defined on the physical domain's border; and
obtaining, by the application module, a numerically-simulated smoothed displacement field of the physical domain subject to the set of boundary conditions by conducting the time-marching simulation using the meshfree model, the smoothed displacement field being derived from a set of smoothed meshfree shape functions that satisfies linear polynomial reproduction condition, wherein the set of smoothed meshfree shape functions, constructed by a convex meshfree approximation scheme and configured to avoid calculating second-order derivatives, is created with a combination of a set of regular meshfree shape functions and a set of displacement smoothing functions for the plurality of particles

8. The system of claim 7, further comprising establishing a domain of influence for each of the plurality of particles, the domain of influence being used for conducting the time-marching simulation more efficiently.

9. The system of claim 8, wherein the set of boundary conditions comprises Dirichlet boundary conditions for prescribed displacement and Neumann boundary conditions for prescribed traction.

10. The system of claim 8, wherein the convex meshfree approximation scheme ensures that the set of smoothed meshfree shape functions comprises Kronecker-delta property.

11. The system of claim 8, wherein the second-order derivatives are results of solving the smoothed displacement field directly from unknown generalized displacement field.

12. The system of claim 8, wherein the regular meshfree shape functions and the displacement smoothing functions are the same.

13. A non-transitory computer readable storage medium containing instructions for obtaining a smoothed displacement field of a physical domain based on smoothed particle Galerkin formulation in solid mechanics by a method comprising:
receiving, in a computer system having an application module installed thereon, a meshfree model representing a physical domain, the meshfree model including a plurality of particles, each configured for material properties of a portion of the physical domain, and a set of boundary conditions defined on the physical domain's border, wherein the application module is configured to perform a time-marching simulation based on smoothed particle Galerkin formulation; and
obtaining, by the application module, a numerically-simulated smoothed displacement field of the physical domain subject to the set of boundary conditions by conducting the time-marching simulation using the meshfree model, the smoothed displacement field being derived from a set of smoothed meshfree shape functions that satisfies linear polynomial reproduction condition, wherein the set of smoothed meshfree shape functions, constructed by a convex meshfree approximation scheme and configured to avoid calculating second-order derivatives, is created with a combination of a set of regular meshfree shape functions and a set of displacement smoothing functions for the plurality of particles

14. The non-transitory computer readable storage medium of claim 13, further comprising establishing a domain of influence for each of the plurality of particles, the domain of influence being used for conducting the time-marching simulation more efficiently.

15. The non-transitory computer readable storage medium of claim 14, wherein the set of boundary conditions comprises Dirichlet boundary conditions for prescribed displacement and Neumann boundary conditions for prescribed traction.

16. The non-transitory computer readable storage medium of claim 14, wherein the convex meshfree approximation scheme ensures that the set of smoothed meshfree shape functions comprises Kronecker-delta property.

17. The non-transitory computer readable storage medium of claim 14, wherein the second-order derivatives are results of solving the smoothed displacement field directly from unknown generalized displacement field.

18. The non-transitory computer readable storage medium of claim 14, wherein the regular meshfree shape functions and the displacement smoothing functions are the same.
